(19) United States
(12) Patent Application Publication
(10) Pub. No.: US 2009/0083302 A1
(43) Pub. Date: Mar. 26, 2009

(54) USING AN INCREMENTING TIME ELEMENT TO SELECTIVELY ADD LIST ITEMS TO EITHER THE START OR THE END OF AN ORDERED LIST

(75) Inventors: MARK C. HAMPTON, NEWTOWN (AU); ERIC T. MARTINEZ DE MORENTIN, MANLY (AU); MATTHEW J. PONSFORD, SYDNEY (AU); KENNETH S. SABIR, MARRICKVILLE (AU)

Correspondence Address: PATENTS ON DEMAND, P.A. - IBM CAM, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/859,892

(22) Filed: Sep. 24, 2007

(51) Int. Cl. G06F 17/30

(52) U.S. Cl. 707/102; 707/E17.001

(57) ABSTRACT

The present invention discloses a solution for establishing position values of new items in an ordered list at either the start or the end of the list without using of markers and without needing to query all the items of the list. In the solution, a command to add a new item to the ordered list can be received, which specifies whether the item is to be added at the start or the end of the list. When the item is to be added to the end of a list, an item position value for a new item can be set equal to a current value of a time element. Otherwise, it can be set equal to negative one times the current value of the time element (assuming smallest to largest ordering). Mathematical derivates that produce the same effect are contemplated.

### BACKGROUND

1. Field of the Invention

The present invention relates to software implemented ordered lists, and more particularly, to using an incrementing time element to selectively add list items to either the start or the end of an ordered list.

2. Description of the Related Art

Many different types of software implemented ordered lists exist. It is a common desire to add a new item to either the beginning or the end of the list. Many different software techniques are used for these lists, each having a set of related disadvantages.

One technique associates a list position value, which can be a number, with each list item. List items are ordered according to their relative list position values. Each time a list item is added to the start of the list, a minimum (assuming ordering from least to greatest) position value for all list items must be determined, and an even lower value must be assigned as the list position value for the new item. Similarly, each time a list item is added to an end of the list, a maximum position value for all list items must be determined and a higher value must be assigned as the list position value for the new item.

One way to determine a minimum or maximum value for list item positions is to query each list item. The more list items that are queried to determine these values, the greater the performance hit. Another way to determine a minimum or maximum position value is to maintain a marker for the highest valued list item position and one for the lowest valued list item position. Markers must be maintained, which again results in a performance hit. Additionally, when a marker is accessible by multiple application processes, which is common when multiple processors are able to interact with a list, the markers need to be synchronized so that only one application process can update/access it at a time.

Another technique for adding list items leverages a time that a new item was added. This technique only permits new list items to be added to an end of the list, since the list is time ordered from oldest to most recent items. A new item cannot be added to a start of a list, nor can a user edit list position values to selectively reposition items relative to each other.

### SUMMARY OF THE INVENTION

The present invention discloses a software solution for ordering list items based on a time element, where the list items can be selectively added to a start of a list or to an end of a list. Further, positions of items in the list can be edited as desired. The solution does not require markers to be maintained for a minimum and maximum list position value. Also, the solution does not require position values be queried each time an item is added to the list. Instead, the invention establishes a continuously incrementing time element, such as a JAVA system time representing a number of milliseconds since Jan. 1, 1970. This number is constantly increasing. An item position is automatically assigned based on the time element. When the item is to be added to an end of the list, the current value for the time element is used. When an item position is to be added to a start of the list, the time element can be multiplied by negative one, and the resulting product can be used as the item position value. These conditions assume that the list is ordered from lowest value to highest value. In one embodiment, the position values of list items can be edited relative to each other to change an order of the list items as desired.

The present invention can he implemented in accordance with numerous aspects consistent with the material presented herein. For example, one aspect of the present invention can include a software maintained ordered list that includes a set of items of an ordered list and a set of programmatic instructions for adding new items to the ordered list. A digitally encoded representation of the items can be stored in a machine readable data store. Each item can have an item position value. The set of programmatic instructions can permit a position to be specified for adding a new item. The position can specify that an item is to be added to a start of the ordered list and can specify that an item is to be added to an end of the ordered list. The set of programmatic instructions can use a continuously increasing (or decreasing) time element to automatically determine an item position value for a newly added item. A first algorithm can be used when determining the item position value for an item to be added to the start of the ordered list. A different second algorithm can be used when determining the item position value for an item to be added to the end of the ordered list. When the ordered list is ordered based on an increasing item position value, the first algorithm can be designed to generate continuously decreasing valued numbers that decrease in proportion to an increase in the current time element value. The second algorithm can be designed to generate continuously increasing valued numbers that increase in proportion to an increase in the current time element value.

Another aspect of the present invention can include a method for establishing position values of items in an ordered list. The method can identify an ordered list including a set of list items, each list item having an item position value that determines its relative position within the ordered list. A command to add a new item to the ordered list can be received. From the command, a determination can be made whether the new item is to be added to a start of the ordered list or to an end of the ordered list, which is specified within a configurable parameter of the command. When the new item is to be added to the start of the ordered list, a first algorithm can execute to determine a new item list position value. When the new item is to be added to the end of the ordered list, a second algorithm can be executed to determine a new item list position value. One of the algorithms can increase in proportion an increase of a continuously increasing time based numeric element while another of the algorithms can decrease in proportion to an increase of the time based numeric element. The new item can be added to the ordered list, where the new item has an item position value equal to the new item list position value.

It should be noted that various aspects of the invention can be implemented as a program for controlling computing equipment to implement the functions described herein, or as a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a system for using a timing element to add new list items at a desired position in accordance with an embodiment of the inventive arrangements disclosed herein.

FIG. 2 is a flow chart of a method for adding a new item to a list at a desired position within the list using a timing element in accordance with an embodiment of the inventive arrangements disclosed herein.

### DETAILED DESCRIPTION OF THE INVENTION

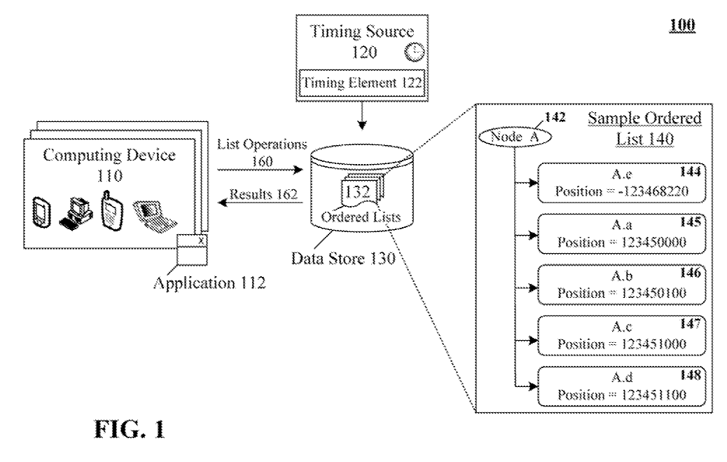

FIG. 1 is a schematic diagram of a system 100 for using a timing element to add new list items at a desired position in accordance with an embodiment of the inventive arrangements disclosed herein. More specifically, one or more computing devices 110 can execute an application 112, which utilizes one or more ordered lists 132 maintained within a data store 130. List operations 160 for manipulating list 132 items can be used to add new items to the list 132, to edit an order of the items within a list 132, to delete items from a list, to view list items, to retrieve one or more list items based in part on position, and the like. Results 162 from a requested operation 160 can be optionally conveyed from the data store 130 to the application 112, which can situationally present result 162 based information upon computing device 110. Each item in the ordered list 132 can have a position attribute or value, which determines an item's position in the list 132. The position value can be based at least in part upon a current value of a timing element 122 obtained from a timing source 120. The timing element 122 can be a continuously incrementing number, which is incremented from a reference start time, which should be a time before the associated ordered list 132 was established. For example, the timing element 122 can be a JAVA system time representing a number in milliseconds since Jan. 1, 1970. Different lists 132 can use the same timing element 122 or can use a different timing element 122 depending on implementation specifics.

Each ordered list 132 can be a software maintained list of items of any nature, so long as a relative position of items within the list is determined based upon a position value associated with each item. An ordered list can represent a stack, an array of values, a set of rows (e.g., each row being a list item) in a table, a set of records (e.g., each record being a list item) in a database, a set of child nodes in a hierarchy having a common parent, and the like. Sample ordered list 140 shows a list of child nodes 144-148 (e.g., list items) of a parent node 142, which is one type of contemplated list able to use the timing element 122.

Ordered child nodes 144-148 can be added to the parent node 142 in a specified order (e.g., placed at the start of a list, at the end of a list, or anywhere in-between) without querying a position of other nodes 144-148 in the list and without maintaining markers of the first (lowest position value) and last (highest position value) nodes. When a new child node (e.g., new list item) is to be added to an end of the list, the current value for the time element 122 can be used. When a new child node is to be added to a start of the list, the current time element 122 value can be multiplied by negative one, and the resulting product can be used as the item position value. In an optional embodiment, a new list item can be placed in any order by ensuring its position value is greater than a node (e.g., list item) immediate before the desired position and less than a position value of a node immediately after the desired position value. Further, a preexisting order of nodes 144-148 can be edited by changing position values of one or more of the nodes 144-148. Permissible values can be constrained to less than an absolute value of a current value of the timing element 122 to ensure that automatic operations to add items to the beginning and ending of a list are not compromised.

The following use case illustrates a use of timing element 122 when adding nodes 144-148 to a list. The child nodes 144-148 of parent Node A 142 can include (listed in temporal order of when the child node was added to the list) Child A.a (node 145), Child A.b (node 146). Child A.c (node 147), Child A.d (node 148), and Child A.e (node 144). Child A.a can be added to the end of the list 140 when a current value of timing element 122 is 123450000. A sample command for adding such a child could be Add_Child (Child A.a, Node A, end_position), which can be an application 112 issued command (160), where a first parameter specifies a child to add to a hierarchical list, the second parameter specifies a parent node, and a final parameter specifies a position at which to add the new node. Child A.b can then be added to the end of the list 140, when the value of the timing element 122 is 123450100. Child A.e can be added to the end of the list 140, when the value of the timing element 122 is 123451000. Child A.d can be added to the end of the list 140, when the value of the timing element 122 is 123451100. Child A.e can be added to the start of the list 140, when the value of the timing element 122 is 123468220. A sample command for adding such a child could be Add_Child ( Child A.e, Node A. start_position).

As used herein, the timing source 120 can be any source having a continuously incrementing value. The timing source 120 can be a standardized clock maintained by an authority, such as a standardized clock maintained in the United States by the National Institute of Standards and Technology (NISI). The timing source 120 can also be a system clock of a server, which manages data store 130. Since multiple different computing devices 110 can access data store 130, it can be preferable that system times from these devices 110 not be used as a timing source 120 unless approximately perfect synchronization is maintained among device 110 system times. Otherwise time differences can cause errors when adding items to an ordered list 132.

The timing element 122 can be a numeric or other ordering element that is continuously incremented as a time of the timing source 120 is incremented. Increment values and/or precision of the timing element 122 need not be identical to those of the timing source 120. For example, the timing source 120 can be incremented in nanosecond increments, while the timing element 122 is incremented in milliseconds. Further, the timing element 122 increment can be twice, half, or any other multiple or fraction of the timing source 120 increment. A precision and an increment value for the timing element 122 can vary from implementation to implementation depending upon an expected update frequency of items in an ordered list 132 and depending upon an expected number of devices 110 able to access the ordered list.

In one embodiment, mathematical transformations and changes to the position values and the timing element 122 can periodically occur, so long as a relative order is maintained after the transformation. For example, when the timing element 122 reaches a previously established threshold, such as 1,125,899,906,842,624 (two to the fiftieth power), the timing source can be reset, such as to one million. All position values can be adjusted so that they possess values between zero and one million, while the order among the list items is maintained. For example, a position value for node 144 can be changed to 1000, a position value for node 145 can be changed to 2000, a position value for node 146 can be changed to 3000, a position value for node 147 can be changed to 4000, and a position value for node 148 can be changed to 5000.

Further, although initial positions are shown as negative values, other implementations can exist. For example, assuming a maximum permitted value of the timing element 122 is 1,125,899,906,842,624, then “positive” values representing values to be added to an end of a list can be equal to the Current Timing Element Value plus 562,949,953,421,312 (e.g., 1,125,899,906,842,624/2) and “negative” values representing values to be added to a beginning of a list can be equal to 562,949,953,421,312 minus the Current Timing Element Value.

Computing device 110 can be any machine capable of sending list operations 160 to the data store 130 and of processing results 162. For example, the computing device 110 can include a personal computer, a notebook computer, a mobile computing device, a smart phone, a personal data assistant (PDA), an embedded computing device, an electronic gaming system, and the like.

Application 112 can be a set of software/firmware/hardware encoded machine readable instructions that utilizes the ordered lists 132 of data store 130. Application 112 can include a standalone program or other software/firmware/hardware implemented routine executing using device 110 resources. Application 112 can also be an application executing remotely that presents results and/or receives input from device 110. In various embodiments, the application 112 can be implemented as a local program, a browser receiving served Web content, a Web service used by device 110, a Rich Internet Application, and the like.

Data store 130 can be physically implemented within any type of hardware including, but not limited to, a magnetic disk, an optical disk, a semiconductor memory, a digitally encoded plastic memory, a holographic memory, or any other recording medium. A data store 130 can be stand-alone storage unit as well as a storage unit formed from a plurality of physical devices, which may be remotely located from one another. Additionally, information can be stored within a data store 130 in a variety of manners. For example, information, such as lists 132, can be stored within a database structure or can be stored within one or more files of a file storage system, where each file may or may not be indexed for information searching purposes.

The various components of system 100 can be communicatively linked via a network (not shown) or through a local communication pathway. The network or pathway can include components capable of conveying digital content encoded within carrier waves. The content can be contained within analog or digital signals and conveyed through data or voice channels and can be conveyed over a personal area network (PAN), a wide area network (WAN), and over circuit board and peripheral device connections. The network can include local components and data pathways necessary for communications to be exchanged among computing device components and between integrated device components and peripheral devices. The network can also include network equipment, such as routers, data lines, hubs, and intermediary servers which together form a packet-based network, such as the Internet or an intranet. The network can further include circuit-based communication components and mobile communication components, such as telephony switches, modems, cellular communication towers, and the like. The network can include line based and/or wireless communication pathways.

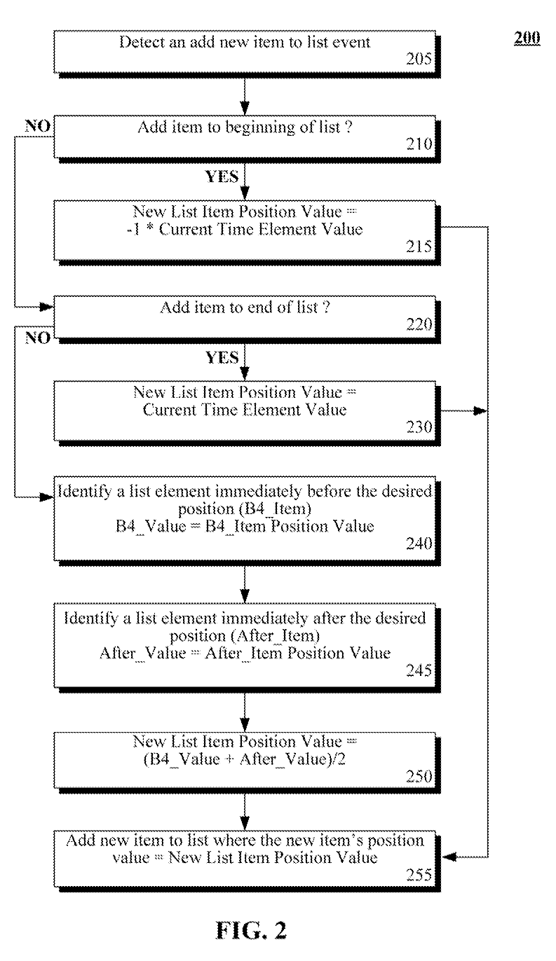

FIG. 2 is a flow chart of a method 200 for adding a new item to a list at a desired position within the list. The method 200 can be performed in the context of system 100. In method 200, the list items can each have a list position value that is based at least in part upon a continuously incrementing time element. The time element can be a numeric value expressed as a quantity of time that has passed from a time reference point, which can be a time at or before the ordered list was initiated. A current value of the time element can be referred to as a Current Time Element Value.

Method 200 can begin in step 205, where an add new item event can be detected. In step 210, a determination can be made to whether the new item is to be added to a beginning of an ordered list. If so, the method can proceed from step 210 to step 215, where a New List Item Position Value can be equal to negative one times the Current Time Element Value. Once the New List Item Position Value is determined, the method can proceed to step 255, where a new item can be added to the list having an item list position value equal to the New List item Position Value.

When the new item is to be added to the end of a list (step 220), the New List Item Position Value can be equal to the Current Time Element Value, as shown in step 230. The method can proceed from step 230 to step 255, where a new item can be added to the list having an item list position value equal to the New List Item Position Value.

When the new item is to be added to a position other than the beginning or ending of a list, the method can proceed to step 240. In step 240, a desired position for the new item must be determined, such as determining an item within the list (e.g., B4_Item) that is to be immediately before the new list item's position and determining an item within the list (e.g., After_Item) that is to be immediately alter the new list item's position. In step 240, the B4_Item can be identified and a B4_Value can be set to the B4_item's list position value. In step 245. The After_Item can be identified and a After_Value can be set to the After_Item's list position value. In step 250, the New List Item Position Value can be equal to one half the sum of the B4_Value and the After_Value. It should be appreciated that the calculation of step 250 can vary to achieve the same effect so long as the New List Item Position Value is greater than the B4_Value and less than the After_Value. The method can proceed from step 250 to step 255, where a new item can be added to the list having an item list position value equal to the New List Item Position Value.

The present invention may be realized in hardware, software or a combination of hardware and software. The present invention may be realized in a centralized fashion in one computer system or in a distributed fashion where different elements are spread across several interconnected computer systems. Any kind of computer system or other apparatus adapted for a carrying out methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than foregoing the specification, as indicating the scope of the invention.

What is claimed is:

1. A software maintained ordered list comprising:
a plurality of items of an ordered list, a digitally encoded representation of said plurality of items being stored in a machine readable data store, each item having an item position value; and
a set of programmatic instructions for adding new items to the ordered list, wherein said set of programmatic instructions permit a position to be specified for adding a new item, said position including at least a start of the ordered list and an end of the ordered list, wherein said set of programmatic instructions use a continuously increasing time element to automatically determine an item position value for a newly added item, wherein a first algorithm is used when determining the item position value for an item to be added to the start of the ordered list and a different second algorithm is used when determining the item position value for an item to be added to the end of the ordered list.

2. The list of claim 1, wherein the second algorithm sets the item position value to a value equal to the current value of the time element.

3. The list of claim 2, wherein the first algorithm sets the item position value to a value equal to negative one times a current value of the time element.

4. The list of claim 1, wherein an order of items in die ordered list is ordered based on an increasing item position value, wherein the first algorithm is designed to generate continuously decreasing valued numbers that decrease in proportion to an increase in the current time element value, and wherein the second algorithm is designed to generate continuously increasing valued numbers that increase in proportion to an increase in the current time element value.

5. The list of claim 1, wherein an order of items in the ordered list is ordered based on a decreasing item position value, wherein the first algorithm is designed to generate continuously increasing valued numbers that increase in proportion to an increase in the current time element value, and wherein the second algorithm is designed to generate continuously decreasing valued numbers that decrease in proportion to an increase in the current time element value.

6. The list of claim 1, further comprising:
a set of programmatic instructions for editing an order of the plurality of items, wherein said editing set of programmatic instructions permit a user to change item position values associated with at least one of the plurality of items.

7. The list of claim 1, wherein the plurality of items represent ordered child nodes of a common parent node of a hierarchically organized set of nodes.

8. The list of claim 1, wherein the set of programmatic instructions establish a public command for adding a new node, wherein one parameter for the public command specifies the new item and wherein another parameter for the public command specifies the position for adding the new number, said position including a value for specifying the start of the ordered list and a value for specifying the end of the ordered list, wherein responsive to receiving a user issued one of the public commands, software managing the ordered list executes the first algorithm or the second algorithm to determine the item position value depending on whether the another parameter specifies a value for the start of the ordered list or a value for the end of the ordered list.

9. A method for establishing position values of items in an ordered list comprising:
identifying an ordered list comprising a plurality of list items, each list item having an item position value that determines its relative position within the ordered list;
receiving a command to add anew item to the ordered list;
determining from the command whether the new item is to be added to a start of the ordered list or to an end of the ordered list, which is specified within a configurable parameter of the command;
when the new item is to be added to the start of the ordered list, executing a first algorithm to determine a new item list position value;
when the new item is to be added to the end of the ordered list, executing a second algorithm to determine a new item list position value; and
adding the new item to the ordered list, where the new item has an item position value equal to the new item list position value, wherein the first algorithm and the second algorithm use a continuously increasing time based numeric element to automatically determine an item position value for a newly added item.

10. The method of claim 9, wherein the new item is selected added to either the start or the end of the list without querying the plurality of list items for their position values and without reliance upon a marker that indicates either a minimum or a maximum position value for the plurality of list items.

11. The method of claim 9, wherein an order of items in the ordered list is ordered based on an increasing item position value, wherein the first algorithm is designed to generate continuously decreasing valued numbers that decrease in proportion to an increase in the time based numeric element, and wherein the second algorithm is designed to generate continuously increasing valued numbers that increase in proportion to an increase in the time based numeric element.

12. The method of claim 9, wherein an order of items in the ordered list is ordered based on a decreasing item position value, wherein the first algorithm is designed to generate continuously increasing valued numbers that increase in proportion to an increase in the time based numeric element, and wherein the second algorithm is designed to generate continuously decreasing valued numbers that decrease in proportion to an increase in the time based numeric element.

13. The method of claim 9, wherein the first algorithm sets the new item list position value to a value equal to negative one times a value of the time based numeric element, and wherein the second algorithm sets the new item list position value to a value equal to a value of the time based numeric element.

14. The method of claim 9, further comprising:
receiving an edit command to edit an order of the plurality of list items; and
responsive to the edit command, changing an item position value of at least one of the plurality of list items.

15. The list of claim 9, wherein the plurality of items represent ordered child nodes of a common parent node of a hierarchically organized set of nodes.

16. The method of claim 9, wherein said steps of claim 9 are performed by at least one machine in accordance with at least one computer program stored in a computer readable media, said computer programming having a plurality of code sections that are executable by the at least one machine.
